(19) United States
(12) Patent Application Publication
(10) Pub. No.: US 2010/0209194 A1
(43) Pub. Date: Aug. 19, 2010

(54) SYSTEM FOR SOIL, GROUNDWATER, AND SURFACE WATER REMEDIATION, AND RELATED METHODS

(75) Inventors: William E. Guite, Bloomfield, CT (US); George E. Hoag, Bloomfield, CT (US); Ralph W. Cook, Norfolk, MA (US)

Correspondence Address: VENABLE LLP, P.O. BOX 34385, WASHINGTON, DC, 20043-9998, US

(73) Assignee: VeruTEK Technologies, Inc., Bloomfield, CT (US)

(21) Appl. No.: 12/680,170

(22) PCT Filed: Sep. 26, 2008
(86) PCT No.: PCT/US08/11228

§ 371 Date: Mar. 25, 2010

(51) Int. Cl. B09C 1/08; C02F 1/72

(52) U.S. Cl. 405/128.75; 210/170.07; 210/170.1; 210/88; 210/101; 210/708

(57) ABSTRACT

A system for soil, groundwater, or surface water remediation, comprises a water supply including a first fluid stream in fluid communication with a first injection point, and a second fluid stream in fluid communication with a second injection point. A first surfactant pump can be adapted to inject a surfactant into the first fluid stream, and a second surfactant pump can be adapted to inject a surfactant into the second fluid stream. A first oxidant pump can be adapted to inject an oxidant into the first fluid stream, and a second oxidant pump can be adapted to inject an oxidant into the second fluid stream.

### CROSS-REFERENCE TO RELATED APPLICATIONS

This patent application claims the priority benefit under 35 U.S.C. §119(e)(1) of U.S. Provisional Application No. 60/960,341, filed on Sep. 26, 2007, the entire content of which is incorporated herein by reference.

### BACKGROUND

This patent application relates generally to systems for use in surface and subsurface remediation of soil, rocks, sand, groundwater, and/or surface water, etc., and related methods. For example, this patent application relates to injection systems and related methods for remediating contaminants in situ, for example, using surfactants or surfactant-cosolvent mixtures and oxidants. This patent application also relates to injection systems and extraction systems used together, for example, for a combination of contaminant extraction and in situ remediation, and related methods.

Soil and/or groundwater remediation typically involves injecting chemicals or other substances into the soil or groundwater to locations proximate the contaminants of concern (COC). The injected chemicals or other substances react with the COCs in situ to eliminate them, to break them down into less harmful substances, and/or to otherwise neutralize them. One type of in situ remediation is referred to as surfactant enhanced in situ chemical oxidation (S-ISCO) remediation, disclosed in applicant's U.S. Published Patent Application No. 2008/0207981, published Aug. 28, 2008, the entire content of which is incorporated herein by reference. S-ISCO remediation can be useful for remediating, for example, manufactured gas plant (MGP) sites, as well as sites with chlorinated solvents, petroleum hydrocarbons, pesticides, herbicides, polychlorinated biphenyls, and other nonaqueous phase liquids (NAPLs) or sorbed COCs.

Some soil remediation processes, such as S-ISCO, may operate entirely in-situ, e.g., without extraction wells or pumps for recovering the injected chemicals and/or by-products of the remediation process. Other soil remediation processes may incorporate a combination of in-situ remediation (e.g., S-ISCO) and extraction. In order to ensure optimum remediation of the COCs, and at the same time, to minimize the level of leftover remediation chemicals and/or by-products of the remediation process, the chemicals should be injected to the proximity of the COCs in precise quantities, compositions, concentrations, and in specific temporal patterns. In addition, since the quantity, composition, and characteristics of the COCs can vary from zone to zone within a given treatment area, it may be necessary to vary the quantity, composition, and concentration of the injected chemicals on a zone-to-zone basis within a single treatment site.

Known injection systems have failed to provide adequate control and precision in the quantity (e.g., flow rate), composition, and concentration of the injected chemicals. For example, some known injection systems, such as the RegenOx™ manufactured by Regenesis, use a batch mixture of chemicals that is injected into a single fluid stream that is subsequently split into multiple fluid streams directed to different zones (e.g., wells) within a single treatment site. This type of system typically does not provide sufficient precision and/or control in the composition, concentration, and/or flow rate of injected chemicals, especially on a well-to-well basis.

### SUMMARY

Further objectives and advantages, as well as the structure and function of exemplary embodiments, will become apparent from a consideration of the description, drawings, and examples.

According to an exemplary embodiment, a system for soil, groundwater, or surface water remediation comprises a water supply including a first fluid stream in fluid communication with a first injection point, and a second fluid stream in fluid communication with a second injection point; a first surfactant pump adapted to inject a surfactant into the first fluid stream, and a second surfactant pump adapted to inject a surfactant into the second fluid stream; and a first oxidant pump adapted to inject an oxidant into the first fluid stream, and a second oxidant pump adapted to inject an oxidant into the second fluid stream.

According to another exemplary embodiment, a system for soil, groundwater, or surface water remediation includes a water supply including at least a first fluid stream in fluid communication with a first injection point; a surfactant storage container containing a surfactant; an oxidant storage container containing an oxidant; a surfactant pump adapted to inject the surfactant into the first fluid stream; and an oxidant pump adapted to inject the oxidant into the first fluid stream.

According to another exemplary embodiment, a method of remediating soil, groundwater, or surface water comprises pumping a first fluid stream of water to a first injection point proximate a first contaminant of concern; injecting a surfactant into the first fluid stream using a first surfactant pump; and injecting an oxidant into the first fluid stream using a first oxidant pump.

According to another exemplary embodiment, a system for soil, groundwater, or surface water remediation, comprises a water supply including at least a first fluid stream in fluid communication with a first injection point; a surfactant pump adapted to inject a surfactant into the first fluid stream; an oxidant pump adapted to inject an oxidant into the first fluid stream; and a contaminant extraction system located proximate the first injection point.

### BRIEF DESCRIPTION OF THE DRAWINGS

The foregoing and other features and advantages of the invention will be apparent from the following drawings wherein like reference numbers generally indicate identical, functionally similar, and/or structurally similar elements.

FIG. 1 is a schematic representation of an exemplary injection system according to the present invention, the injection system including three injection points;

FIGS. 2A through 2D depict exemplary injectors for use with the injection system of FIG. 1;

FIG. 3 is a schematic representation of an exemplary extraction system in combination with the injection system of FIG. 1; and

FIGS. 4A through 4D depict an exemplary remediation process incorporating extraction and in situ remediation.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without parting from the spirit and scope of the invention. All references cited herein are incorporated by reference as if each had been individually incorporated.

“Contaminants” encompasses any substance present in a location that, by its presence, diminishes the usefulness of the location for productive activity or natural resources, or would diminish such usefulness if present in greater amounts or if left in the location for a length of time. The location may be subsurface, on land, in or under the sea or in the air. As used herein, “contaminated soil” encompasses any soil that contains at least one contaminant according to the present invention. “Contaminant” thus can encompass trace amounts or quantities of such a substance. Examples of productive activities include, without limitation, recreation; residential use; industrial use; habitation by animal, plant, or other life form, including humans; and similar such activities. Examples of natural resources are aquifers, wetlands, sediments, soils, plant life, animal life, and ambient air quality.

“Introduce” means to cause to be present in a location. A material or item can be introduced into a location even if the material or item is released somewhere else and must travel some distance in order to reach the location. For example, if a substance is released at location A, and the substance will migrate over time to location B, the substance has been “introduced” into location B when it is released at location A. An item can be introduced in any manner appropriate under the circumstances for the substance to be introduced into the location.

An “effective amount” encompasses an amount of a material or item that will bring about a decrease in the amount of one or more contaminants in a location. An “effective amount” also encompasses an amount that brings about a stabilization of contaminant amounts or quantities in a location where they would otherwise increase or remain constant. It also encompasses an amount that brings about a reduction in the rate of increase of the amount or quantity of a contaminant in a location, as compared to the rate that would have obtained had the material or item not been introduced.

“Activate” means to modify or alter a substance in such a way that the substance is able to perform a function it was unable, or less able, to perform prior to activation. For example, “activation” encompasses the conversion of a persulfate ion into sulfate free radical, which is then able to oxidize other substances in a location.

“Expose” means to cause to be, or become, available for interaction with other substances in the surroundings. For example, once a polymer-coated nanoparticle is “exposed,” it is available to come into contact, chemically react, or otherwise interact with chemicals in the location into which it has been introduced.

A “reducing environment” or “reducing zone” is an environment in which substances are generally more likely to be reduced—e.g., have their oxidation numbers reduced, or gain electrons—than they are in another location. A reducing environment can also be conducive to the growth and metabolism of anaerobic organisms, as a reducing environment will eliminate species, such as oxygen, that might otherwise interfere with their growth or development.

An “oxidizing environment” or “oxidizing zone” is an environment in which substances are generally more likely to be oxidized—e.g., have their oxidation numbers increased, or lose electrons—than they are in another location. An oxidizing environment can also be conducive to the growth and metabolism of aerobic organisms.

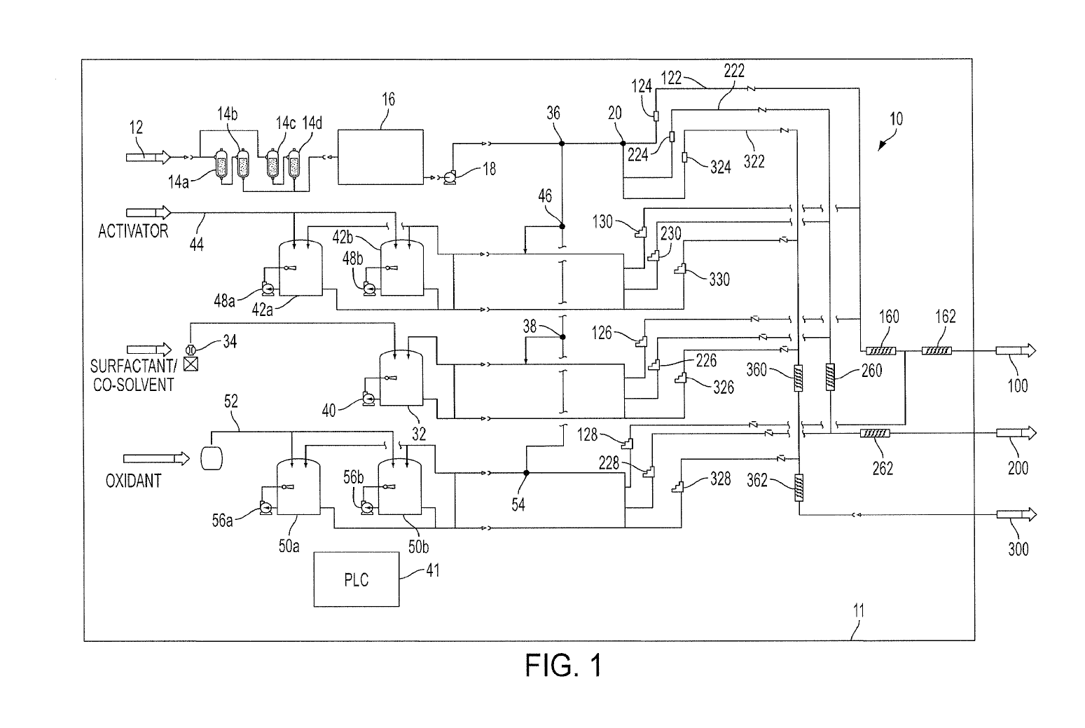

Referring to FIG. 1, a schematic representation of an exemplary injection system 10 is shown. Injection system 10 can be used in the remediation of contaminated soil and/or groundwater, for example, using an in situ remediation process such as the S-ISCO process disclosed in U.S. Published Patent Application No. 2008/0207981, published Aug. 28, 2008, the entire content of which is incorporated herein by reference. In S-ISCO, surfactants and/or cosolvents can be injected into the soil, groundwater, and/or surface water, etc. The surfactants and/or cosolvents can facilitate contact between the contaminants or COCs and an injected substance such as, for example, an oxidant, and thereby promote elimination, breakdown, or another form of neutralization of the contaminants or COCs by the injected substance. For example, the surfactants and/or cosolvents can induce the formation of a Winsor Type I system within a nonaqueous phase liquid (NAPL) contaminant and thereby promote diffusion of an injected oxidant or species derived therefrom, such as persulfate, to the NAPL, so that the injected oxidant or species derived therefrom oxidizes the NAPL. The injection system disclosed herein is not limited to use with S-ISCO, however, and can alternatively be used with other remediation processes, such as, for example, in-situ chemical oxidation (ISCO) and surfactant-enhanced aquifer remediation (SEAR). In addition, the injection system disclosed herein can be used in combination with an extraction system, for example, to provide a combination of extraction and in-situ remediation.

Injection system 10 can be used to inject chemicals or other substances to one or more injection points at a treatment site. According to an exemplary embodiment, system 10 can be used to inject an oxidant, a surfactant or surfactant/co-solvent mixture (referred to herein generally as a “surfactant”), and optionally an activator to each of the injection points to remediate COCs proximate the injection points. In the exemplary embodiment shown in FIG. 1, system 10 is adapted to inject chemicals to three different injection points 100, 200, 300, however, the system 10 can be scaled up or down to accommodate any number of injection points, as will be appreciated by one of ordinary skill in the art.

The injection points 100-300 can be located subsurface, and can comprise, for example, injection wells, injection trenches, or temporary injection sites. The injection points 100-300 can additionally or alternatively be located above surface, and can comprise, for example, the surface of the ground, such as surface-contaminated soils, rocks, beaches, or orchards. The injection points 100-300 can additionally or alternatively comprise, for example, the surface or subsurface of water, such as an ocean, lake, river, or reservoir. One of ordinary skill in the art will know that other types and locations of injection points known in the art are possible. The COCs can be the same at each injection point 100-300, or alternatively, can vary from one injection point to another. The injection points 100-300 can all be spaced apart from one another, or alternatively, one or more of the injection points 100-300 can partially or fully overlap one another, for instance, were the concentration of the COC is very high in a specific location.

It may be advantageous to vary the composition, concentration, and/or quantity of injected chemicals from one injection point to another, for example, to account for the quantity, composition, and/or characteristics of the COC proximate each injection point. It may also be advantageous to vary the composition, concentration, and/or quantity of the injected chemicals based on the spatial distribution of the COC at each injection point, and/or based on the properties of the soil, groundwater, subsurface, etc., surrounding the COC at each injection point. It may also be advantageous to modify the amounts of materials delivered over time. In order to provide increased precision and control over the substances injected to each injection point, the system 10 can include a dedicated pump for each chemical component injected at each injection point, as will be described in more detail below.

### Water Supply

Referring to FIG. 1, system 10 can include a water supply 12, which may comprise, for example, water from a fire hydrant, although, other sources of water, both public and private, can alternatively be used. Water can flow downstream from the water supply 12 and pass through one or more filters, which can remove particles such as iron from the water. The non-limiting embodiment of FIG. 1 includes four filters 14a-d, however, any number of filters, or even no filters at all, can alternatively be used as may be necessitated, for example, by the quality of the water from the water supply 12, and/or the sensitivity of the injected chemicals to substances in the water.

The water can enter a holding tank 16 that can act, for example, as a capacitor, in case of sudden increases in the demand for water which may exceed the pressure or flow capabilities of the water supply 12. According to an exemplary embodiment, the holding tank 16 can comprise a Baker tank having a capacity of 5,000 to 20,000 gallons, however, other types and sizes of holding tank(s) are possible.

A water pump 18 can pump water from the holding tank 16 to one or more of the injection points 100-300. According to the exemplary embodiment shown in FIG. 1, a single, common water pump can pump the water to each of the injection points 100-300. Water pump 18 can comprise a centrifugal pump having a capacity in the range of about 0 to about 25 gpm, for example. Alternatively, one or more water pumps can be dedicated to each injection point 100-300, however, this configuration can be more costly than having a common water pump. In the case where a common water pump is used, the water flow from the pump 18 can be divided into multiple fluid streams at divider 20, with each stream leading to a different injection point. For example, in the exemplary embodiment shown, divider 20 separates the water stream into a first fluid stream 122 leading to the first injection point 100, a second fluid stream 222 leading to the second injection point, and a third fluid stream 322 leading to the third injection point 300. When referring to fluid or water streams, flows, etc., it is to be understood that the streams, flows, etc., are directed by pipes, tubes, hoses, trenches, or other types of conduits known in the art.

According to the exemplary embodiment where a common water pump 18 is used, an adjustable flow meter can be included in each fluid flow upstream of the respective injection point, to control the flow rate of water to that injection point. For example, as shown in FIG. 1, a first inline flow meter 124 can control the flow rate of water to the first injection point 100, a second inline flow meter 224 can control the flow rate of water to the second injection point 200, and a third inline flow meter 324 can control the flow rate of water to the third injection point 300. The flow meters can comprise rotometers having a flow range of about 0 to about 25 gpm, however, other types and sizes of flow meters may be used based on the needs of a specific application of the system 10. The flow meters 124, 224, 324 can be controlled by a centralized controller, for example, a programmable logic controller (PLC) 41.

### Injector(s)

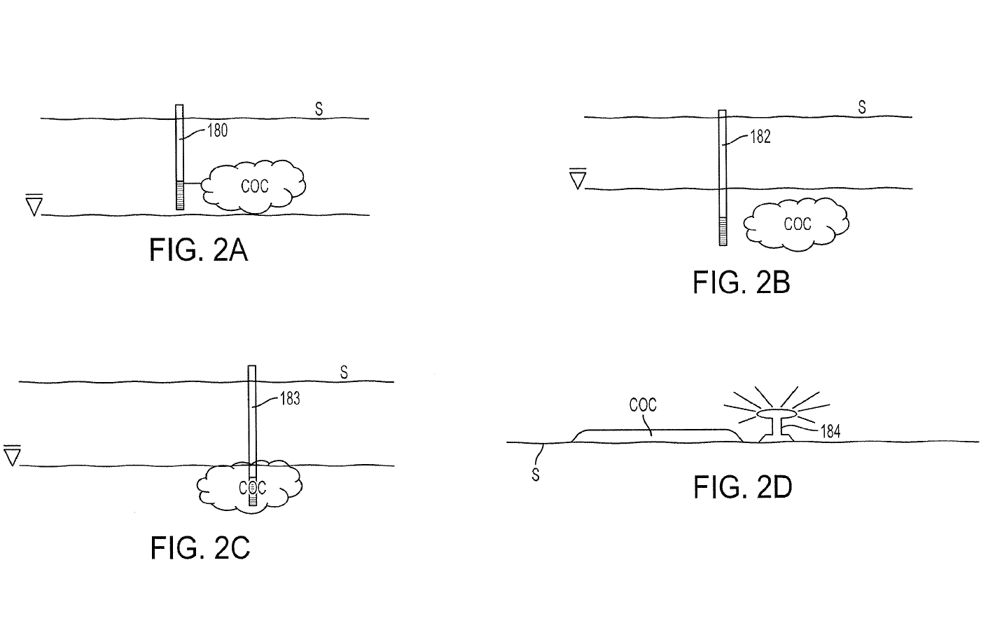

The system 10 can include injectors adapted to inject the chemicals proximate each injection point 100, 200, 300. For example, a first injector can inject chemicals proximate injection point 100, a second injector can inject chemicals proximate injection point 200, and a third injector can inject chemical proximate injection point 300. FIGS. 2A-D depict injectors that can be used with system 10. The injectors can inject the chemicals toward the COC, below surface, as shown in FIGS. 2A and 2B, and/or directly into the COC, below surface as shown in FIG. 2C, for example, to force apart saturated pockets of COC. Alternatively, the injectors can spray the chemicals at or into the COC above surface, as shown in FIG. 2D. FIG. 2A, a suitable injector can comprise an injection conduit or pipe 180, which may or may not be flexible, that extends into the soil, beneath the surface S, toward and/or into the COC. The pipe 180 may be mounted in the soil, for example, with its terminal end located proximate the COC. Referring to FIG. 2B, a suitable injector can alternatively comprise an injection conduit or pipe 182, which may or may not be flexible, that extends into groundwater, beneath the surface S, toward and/or into the COC. Referring to FIG. 2C, a suitable injector can alternatively comprise an injection conduit or pipe 183, which may or may not be flexible, that extends into the COC, which is partially located in the soil, and partially located in the groundwater. Referring to FIG. 2D, a suitable injector can alternatively comprise a sprinkler 184 located, for example, above surface S near the COC. The sprinkler 184 can spray the remediation chemical at or onto the COC. The injectors are typically comprised of a stainless steel or PVC/HDPE conduit with an opening or screen in the subsurface at the point of discharge. One of ordinary skill in the art will appreciate that other types of injectors, those used both above surface and below surface, can alternatively be used with system 10.

### Surfactant

As mentioned previously, the system 100 can include a dedicated injection pump for each chemical component injected to each injection point. For example, with reference to injection point 100 in FIG. 1, a first surfactant pump 126 can be controlled, for example, by PLC 41, to inject a surfactant or surfactant/co-solvent (referred to hereinafter generally as a “surfactant”) into the water stream 122 leading to the first injection point 100; a first oxidant pump 128 can be controlled, for example, by PLC 41, to inject an oxidant into the water stream 122 leading up to the first injection point 100; and/or a first activator pump 130 can be controlled, for example, by PLC 41, to inject a chemical activator into the water stream 122 leading up to the first injection point 100. Along these lines, sets of second and third surfactant pumps 226, 326, oxidant pumps 228, 328, and/or activator pumps 230, 330 can be controlled to inject a surfactant, oxidant, and/or activator into the water flows 222, 322 leading to the second and third injection points 200, 300, respectively. Each of the aforementioned pumps and related structures will be described in more detail below.

Still referring to FIG. 1, a surfactant storage container 32 can hold a surfactant or surfactant/co-solvent mixture (generally, “surfactant”), for example, in liquid form. The surfactant can be introduced into the container 32 from bulk storage (e.g., in powder or concentrated liquid form) and introduced into the container 32, for example, using a pump 34. When in the storage container 32, the surfactant in powder or concentrated form can be mixed with water from the water supply 12, which can be fed off the main water flow at divider 36 and subsequently directed to the surfactant container 32 at divider 38. A mixing system, such as a eductor pump 40, can circulate the diluted surfactant through the storage container 32 (e.g., from top to bottom), to maintain an even mixture of the surfactant within the surfactant container 32.

According to an exemplary embodiment of the invention, the surfactant can comprise a substance made from a naturally occurring biodegradable plant oil. A surfactant and/or cosolvent can be or can be derived from a plant extract or a biodegradable plant extract. Additionally or alternatively, the surfactant can comprise a substance made from castor oil, coca oil, coconut oil, soy oil, tallow oil, cotton seed oil, or a naturally occurring plant oil. Additionally or alternatively, the surfactant can comprise Citrus Burst 1, Citrus Burst 2, Citrus Burst 3, or E-Z Mulse. Additionally or alternatively, the surfactant can comprise ALFOTERRA 53, ALFOTERRA 123-8S, ALFOTERRA 145-8S, ALFOTERRA L167-7S, ETHOX HCO-5, ETHOX HCO-25, ETHOX CO-5, ETHOX CO-40, ETHOX ML-5, ETHAL LA-4, AG-6202, AG-6206, ETHOX CO-36, ETHOX CO-81, ETHOX CO-25, ETHOX TO-16, ETHSORBOX L-20, ETHOX MO-14, S-MAZ 80K, T-MAZ 60 K 60, TERGITOL L-64, DOWFAX 8390, ALFOTERRA L167-4S, ALFOTERRA L123-4S, or ALFOTERRA L145-4S. As mentioned previously, the surfactant can comprise a surfactant/co-solvent mixture, in which case, the co-solvent can comprise of dilimnone, terpinoids, alchohols, or plant-based solvents. Further examples of surfactants and surfactant/co-solvent mixtures include terpenes, citrus-derived terpenes, limonene, d-limonene, castor oil, coca oil, coconut oil, soy oil, tallow oil, cotton seed oil, and a naturally occurring plant oil. The surfactant and/or cosolvent can be a nonionic surfactant, such as ethoxylated soybean oil, ethoxylated castor oil, ethoxylated coconut fatty acid, and amidified, ethoxylated coconut fatty acid. For example, a composition of surfactant and cosolvent can include at least one citrus terpene and at least one surfactant. A citrus terpene may be, for example, CAS No. 94266-47-4, citrus peels extract (citrus spp.), citrus extract, Curacao peel extract (Citrus aurantium L.), EINECS No. 304-454-3, FEMA No. 2318, or FEMA No. 2344. A surfactant may be a nonionic surfactant. For example, a surfactant may be an ethoxylated castor oil, an ethoxylated coconut fatty acid, or an amidified, ethoxylated coconut fatty acid. An ethoxylated castor oil can include, for example, a polyoxyethylene (20) castor oil, CAS No. 61791-12-6, PEG (polyethylene glycol)-10 castor oil, PEG-20 castor oil, PEG-3 castor oil, PEG-40 castor oil, PEG-50 castor oil, PEG-60 castor oil, POE (polyoxyethylene) (10) castor oil, POE(20) castor oil, POE (20) castor oil (ether, ester), POE(3) castor oil, POE(40) castor oil, POE(50) castor oil, POE(60) castor oil, or polyoxyethylene (20) castor oil (ether, ester). An ethoxylated coconut fatty acid can include, for example, CAS No. 39287-84-8, CAS No. 61791-29-5, CAS No. 68921-12-0, CAS No. 8051-46-5, CAS No. 8051-92-1, ethyoxylated coconut fatty acid, polyethylene glycol ester of coconut fatty acid, ethoxylated coconut oil acid, polyethylene glycol monoester of coconut oil fatty acid, ethoxylated coco fatty acid, PEG-15 cocoate, PEG-5 cocoate, PEG-8 cocoate, polyethylene glycol (15) monococoate, polyethylene glycol (5) monococoate, polyethylene glycol 400 monococoate, polyethylene glycol monococonut ester, monococonate polyethylene glycol, monococonut oil fatty acid ester of polyethylene glycol, polyoxyethylene (15) monococoate, polyoxyethylene (5) monococoate, or polyoxyethylene (8) monococoate. An amidified, ethoxylated coconut fatty acid can include, for example, CAS No. 61791-08-0, ethoxylated reaction products of coco fatty acids with ethanolamine, PEG-11 cocamide, PEG-20 cocamide, PEG-3 cocamide, PEG-5 cocamide, PEG-6 cocamide, PEG-7 cocamide, polyethylene glycol (11) coconut amide, polyethylene glycol (3) coconut amide, polyethylene glycol (5) coconut amide, polyethylene glycol (7) coconut amide, polyethylene glycol 1000 coconut amide, polyethylene glycol 300 coconut amide, polyoxyethylene (11) coconut amide, polyoxyethylene (20) coconut amide, polyoxyethylene (3) coconut amide, polyoxyethylene (5) coconut amide, polyoxyethylene (6) coconut amide, or polyoxyethylene (7) coconut amide. Examples of surfactants derived from natural plant oils are ethoxylated coca oils, coconut oils, soybean oils, castor oils, corn oils and palm oils. Many of these natural plant oils are US FDA GRAS.

Additional surfactants and surfactant/co-solvent mixtures, and details regarding the same, are described in the aforementioned U.S. Published Patent Application No. 2008/0207981.

A surfactant pump can be dedicated to each injection point 100-300, and inject surfactant from the surfactant container 32 to the respective injection point. For example, as shown in FIG. 1, the first surfactant pump 126 can be operated to inject surfactant from the surfactant container 32 into the water flow leading to the first injection point 100. First surfactant pump 126 can comprise a variable speed, proportional metering pump of the single diaphragm type having an operating range of about 0 to about 48 gph. Second and third surfactant pumps 226, 326 can be dedicated to the second and third injection points 200, 300, respectively. Therefore, by controlling the flow rate of one of the surfactant pumps, it is possible to control the amount of surfactant being introduced into the water stream leading to the respective injection point. Each of the surfactant pumps 126, 226, 326 can be controlled individually, for example, using the aforementioned PLC 41. For example, the flow rate of the first surfactant pump 126 can be different than the flow rate of the second surfactant pump 226, and/or the third surfactant pump 326. This makes it possible to introduce different amounts of surfactant into each injection point, without necessarily changing the flow rate of water to each injection point. As a result, both the absolute amount of surfactant, as well as the concentration of the surfactant in the water flow, can be varied across all injection points 100-300.

According to another exemplary embodiment, the system can comprise multiple surfactant containers. For example, a different surfactant container may be associated with each surfactant pump, or one surfactant container may be associated with subsets of surfactant pumps. According to this configuration, different surfactants may be stored in different surfactant containers, allowing different surfactants to be introduced into each injection site, or groups of injection sites. This can permit the surfactant to be tailored to the COC, soil conditions, or other parameters at each injection site.

### Activator

An activator storage container can hold a chemical activator, for example, in liquid form. In the exemplary embodiment of FIG. 1, two activator containers 42a, 42b are shown, however system 10 can alternatively include more or less than two activator storage containers. Activator can be introduced into the first and/or second containers 42a, 42b in bulk form (e.g., powder or concentrated liquid) by pumping it, blowing it, pouring it, or otherwise introducing it into conduit 44. When in the storage containers 42a, 42b, activator in powder or concentrated form can be mixed with water from the water supply 12, which can be fed off the main water flow at divider 36 and subsequently directed to the activator containers 42a, 42b at divider 46. A mixing system, such as eductor pumps 48a, 48b, can circulate the diluted activator through the respective storage container 42a, 42b (e.g., from top to bottom), to maintain an even mixture of activator within each activator container 42a, 42b. According to an exemplary embodiment, both containers 42a, 42b can contain the same activator, in which case, having two containers can allow the activator in one container to be refilled and/or mixed while the activator in the other container is being supplied to the injection sites. Alternatively, the two containers 42a, 42b can contain different chemical activators, which can allow rapid switching from one activator to another, or else, the provision of different activators to different wells.

According to an exemplary embodiment of the invention, the activator can comprise, for example, a metal, a zero valent metal (e.g., zero valent iron, manganese, cobalt, palladium, or silver), a chelated metal, a chelated iron, Fe-NTA, Fe(II)-EDTA, Fe(III)-EDTA, Fe(II)-citric acid, and/or Fe(III)-citric acid. Additional exemplary activators can include a base (e.g., NaOH), heat, hydrogen peroxide, or oxidants. Additional activators and details regarding the same are described in the aforementioned U.S. Published Patent Application No. 2008/0207981.

An activator pump can be dedicated to each injection point 100-300, and can inject activator from one or both of the activator containers 42a, 42b to the respective injection point. For example, as shown in FIG. 1, the first activator pump 130 can be operated, for example, by PLC 41, to inject activator from the activator container 42a and/or 42b into the water flow 122 leading to the first injection point 100. First activator pump 130 can comprise a variable speed, proportional metering pump of the single diaphragm type having an operating range of about 0 to about 48 gph. Second and third activator pumps 230, 330 can be dedicated to the second and third injection points 200, 300, respectively. Therefore, by controlling the flow rate of one of the activator pumps, it is possible to control the amount of activator being introduced into the water stream leading to the respective injection point. Each of the activator pumps can be controlled individually, for example, using the PLC 41. For example, the flow rate of the first activator pump 130 can be different than the flow rate of the second activator pump 230, and/or the third activator pump 330. As a result, it is possible to introduce different amounts of activator into each injection point 100, 200, 300, without necessarily changing the flow rate of water to each injection point. As a result, both the absolute amount of activator, as well as the concentration of the activator in the water flow, can be varied across all injection points 100-300.

As described above, according to an exemplary embodiment, the activator container 42a can contain a different activator than container 42b. According to this embodiment, some of the activator pumps may draw activator from container 42a, while others may draw activator from container 42b, allowing different activators to be introduced into different injection sites. According to another exemplary embodiment, a different storage container can be associated with each injection site 100-300, allowing a different activator to be injected into each injection site 100-300. This can permit the activator to be tailored to the COC, soil conditions, or other parameters at each injection site.

### Oxidant

Referring to FIG. 1, an oxidant storage container can hold an oxidant, for example, in liquid form. In the exemplary embodiment of FIG. 1, two oxidant containers 50a, 50b are shown, however system 10 can alternatively include more or less than two oxidant storage containers. Oxidant can be introduced into the first and/or second oxidant containers 50a, 50b in bulk form (e.g., powder or concentrated liquid) by pumping it or otherwise introducing it into conduit 52. When in the storage containers 50a, 50b, oxidant in powder or concentrated form can be mixed with water from the water supply 12, which can be fed off the main water flow at divider 36 and subsequently directed to the activator containers 42a, 42b at point 54. A mixing system, such as eductor pumps 56a, 56b, can circulate the diluted oxidant through the respective storage container 50a, 50b (e.g., from top to bottom), to maintain an even mixture of oxidant within each oxidant container 50a, 50b. According to an exemplary embodiment, both containers 50a, 50b can contain the same oxidant, in which case, having two containers can allow the oxidant in one container to be refilled and/or mixed while the oxidant in the other container is being supplied to the injection sites. Alternatively, the two containers 50a, 50b can contain different oxidants, which can allow rapid switching from one oxidant to another, or else, the provision of different oxidants to different injection sites.

According to an exemplary embodiment of the invention, the oxidant can comprise a persulfate, sodium persulfate, ozone, oxygen, air, peroxide, hydrogen peroxide, a peroxide compound, a permanganate compound, or a percarbonate compound. Additional oxidants and details regarding the same are described in the aforementioned U.S. Published Patent Application No. 2008/0207981.

An oxidant pump can be dedicated to each injection point 100-300, and can inject oxidant from one or both of the oxidant containers 50a, 50b to the respective injection point. For example, as shown in FIG. 1, the first oxidant pump 128 can be operated, for example, by PLC 41, to inject oxidant from the oxidant container 50a and/or 50b into the water flow leading to the first injection point 100. First oxidant pump 128 can comprise a variable speed, proportional metering pump of the single diaphragm type having an operating range of about 0 to about 48 gph. Second and third oxidant pumps 228, 238 can be dedicated to the second and third injection points 200, 300, respectively. Therefore, by controlling the flow rate of one of the oxidant pumps, it is possible to control the amount of oxidant being introduced into the water stream leading to the respective injection point. Each of the oxidant pumps can be controlled individually, for example, using the PLC 41, thereby making it possible to introduce different amounts of oxidant into each injection point, without necessarily changing the flow rate of water to each injection point. For example, the flow rate of the first oxidant pump 128 can be different than the flow rate of the second oxidant pump 228, and/or the third oxidant pump 328. As a result, both the absolute amount of oxidant, as well as the concentration of the oxidant in the water flow, can be varied across all injection points 100-300.

As described above, according to an exemplary embodiment, the oxidant container 50a can contain a different oxidant than container 50b. According to this embodiment, some of the oxidant pumps may draw oxidant from container 50a, while others may draw oxidant from container 50b, allowing different oxidants to be introduced into different injection sites. According to another exemplary embodiment, a different oxidant storage container can be associated with each injection site 100-300, allowing a different oxidant to be injected into each injection site 100-300. This can permit the oxidant to be tailored to the COC, soil conditions, or other parameters at each injection site.

### Mixers

Still referring to FIG. 1, mixers located in the various fluid flows can be used to mix the activator, surfactant, and/or oxidant in the water flows leading up to the injection points 100-300. For example, an inline mixer 160 can be provided in communication with the fluid flow 122 leading up the first injection point 100. Inline mixer 160 can be located downstream of the point(s) where the activator and surfactant enter the water flow 122, thereby mixing the surfactant and activator together in the water flow prior to reaching the injection point 100. Inline mixer 160 can be of the screw- or spiral-type, which can cause turbulence in the fluid flow through the mixer 160, and as a result, can cause mixing of the activator and surfactant. Other types of mixers, such as increasing the piping length after introducing an injected stream, can alternatively be used. Inline mixers 260, 360 (e.g., similar to the inline mixer 160), can be provided in the fluid flows 222, 322 leading up to the second and third injection points 200, 300, respectively.

Another inline mixer 162 can also be located in the fluid stream leading up to the first injection point. Inline mixer 162 can be located downstream of mixer 160, and/or can be located downstream of the point where the oxidant enters the fluid stream 122. Accordingly, inline mixer 162 can mix the oxidant with the water stream containing the already mixed activator and surfactant. Similar inline mixers 262, 362 can be provided in fluid communication with the fluid flows 222, 322 leading up to the second and third injection points 200, 300, respectively. Combining and mixing the surfactant, oxidant, and/or activator prior to injection can enhance the coelution of the chemicals, making the remediation process more efficient.

According to an exemplary embodiment, the system 10 can be mounted on a skid 11 to facilitate transportation of the system 10, for example, from site to site. According to an exemplary embodiment, the storage containers, pumps, mixers, and/or other components of the system 10 can be secured to the skid 11.

### Method

As mentioned previously, system 10 can be used in a method of remediating soil or groundwater, for example, organic contaminated soil or groundwater. According to an exemplary embodiment, the system 10 can be used to remediate manufactured gas plant sites. Additionally or alternatively, system 10 can be used in remediating sites with chlorinated solvents, petroleum hydrocarbons, pesticides, herbicides, polychlorinated biphenyls, and other NAPLs or sorbed COCs. The method can begin with assessing the condition of the soil, groundwater, etc., to be treated. This can be done, for example, using one or more monitoring wells to determine the type, quantity, and distribution of the various COCs.

The method can generally include pumping a first fluid stream of water to a first injection point 100, for example, proximate a first contaminant of concern, injecting a surfactant into the first fluid stream using, for example, the first surfactant pump 126, and injecting an oxidant into the first fluid stream using, for example, the first oxidant pump 128. The method can further include injecting an activator into the first fluid stream using, for example, the first activator pump 130. The method can further include pumping at least second and third fluid streams of water to second and third injection points 200, 300, and injecting surfactant, oxidant, and/or activator into each of the second and third fluid streams using, for example, respective second and third surfactant pumps 226, 326, second and third oxidant pumps 228, 328, and/or second and third activators pumps 230, 330.

By having independent pumping systems for each injection point, different chemical compositions, quantities, and/or concentrations can be deployed over a given treatment site on a zone-to-zone basis. For example, it is possible to vary the flow rate, concentration, and/or composition of the injected compounds (e.g., surfactant, oxidant, and/or activator) from one injection point to another. This can allow the type and quantity of injected substances to be tailored to the specific COCs proximate each injection point, and/or to the geological or hydrogeological conditions proximate each injection point—which can be determined using one or more monitoring wells prior to, or concurrently with the pumping steps.

According to an exemplary subsurface embodiment of the remediation method, the injected chemicals (e.g., surfactant, oxidant, and activator) are not extracted from the ground following the remediation process. For example, the activator and oxidant react completely with the COCs to neutralize them, and the surfactant biodegrades. Additionally or alternatively, by-products of the remediation process, if any, are not extracted after the remediation process.

The surfactant pumps 126, 226, 326, oxidant pumps 128, 228, 328, and/or activator pumps 130, 230, 330, as well as the flow meters 124, 224, 324 can be controlled to perform the remediation process using, for example, PLC 41 or some other computer-based controller, as will be appreciated by one of ordinary skill in the art. The process can be performed manually, automatically, or by some combination of manual and automatic processes. According to an exemplary embodiment, the process can be controlled using telemetry. For example, the metering pumps and/or centrifugal pump can be connected through a PLC, which can be dialed into via telephone and controlled by a computer using telemetry software.

Once the remediation process is complete, the condition of the soil, groundwater, etc., can again be evaluated, for example, using one or more monitoring wells.

### Extraction

The system and method described herein can further provide for physical extraction of the COCs. For example, in certain circumstances, it may be advantageous to extract a portion of the COCs from the soil or groundwater before, during, or after remediation using the S-ISCO process. For example, extraction may be used to remove gross amounts of a NAPL prior to, or concurrently with the S-ISCO process, which may help reduce oxidant demand and cost. A surfactant may be injected into or near the COC prior to the extraction in order to aid the extraction process.

Additionally or alternatively, an extraction system may be used to create a man-made water flow during the S-ISCO process, which may be particularly helpful in cases where natural water flow provides very low or no transport of the S-ISCO chemicals (e.g., with a stagnant pocket or pool of COC). Additionally or alternatively, an extraction well can be placed between the COC and a sensitive receptor, such a house, in order to provide a buffer between the S-ISCO chemicals and the sensitive receptor.

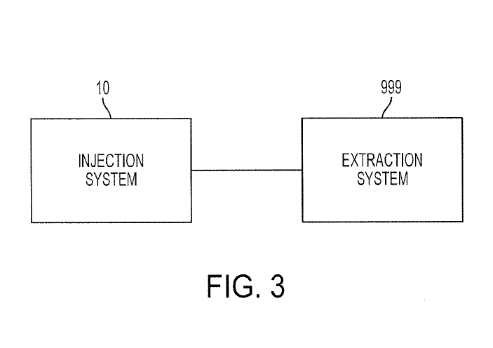

FIG. 3 schematically represents an extraction system 999 in combination with the injection system 10 of FIG. 1. The extraction system can generally comprise suction hoses or pipes, located, for example, in the soil or in the groundwater, that suction away portions of the COCs and/or groundwater, reducing NAPL plumes and/or enhancing groundwater transport. For example, the extraction system 999 can comprise a pump, blower, or other apparatus that applies vacuum on a conduit or well. The extraction system 999 is not limited to the examples provided above, and one of ordinary skill in the art will appreciate than many other extraction systems known in the art can alternatively be used.

### Example

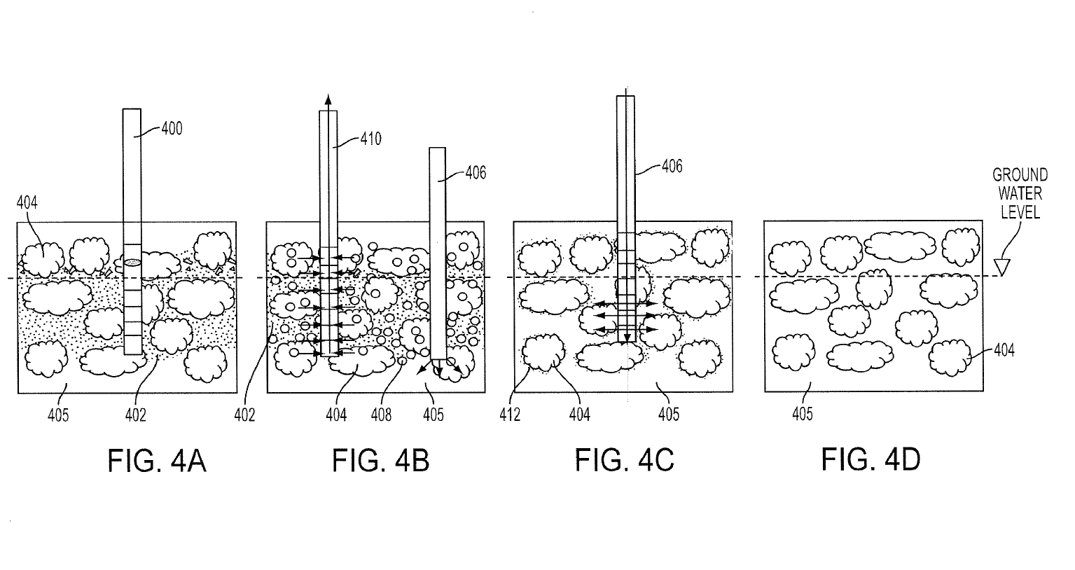

Referring to FIGS. 4A-D, an exemplary sub-surface soil remediation process according to the present invention is shown. At the beginning of the process, one or more monitoring wells can be used to evaluate the initial condition of the soil at the remediation site. For example, the monitoring well 400 shown in FIG. 4A can be used to determine the quantity, type, and/or distribution of COCs at the remediation site, which in the example shown, comprise NAPLs 402 bound to soil particles 404 atop groundwater.

As shown in FIG. 4B, an injection well 406 can be used to inject an oxidant (e.g., hydrogen peroxide), a surfactant, and optionally sodium bicarbonate into the treatment site, for example, using the pumps described above with respect to extraction system 10. Using hydrogen peroxide as the oxidant can cause the production of scrubbing oxygen micro bubbles 408, which can loosen up and release the COCs 402 from the soil particles 404. The surfactant may reduce the interfacial tension of the COCs 402. The combined effect of the oxidant (e.g., hydrogen peroxide) and the surfactant can solubize the COCs 402 in the groundwater 405. The solubized COCs 402 can then be recovered using one or more contaminant extraction wells 410.

FIG. 4C depicts the state where all or most of the solubized COCs have been removed through the contaminant extraction well 410, and mainly residual COCs 412 bound to the soil particles 404 remain. At this point, extraction can be terminated, and the extraction wells 410 can be removed. However, in-situ remediation continues (or begins). For example, the extraction system 10, described above, can be used to inject water along with a surfactant, oxidant, and optional activator into the treatment site using the injection well 406. A monitoring well (not shown) can be used to monitor the condition of the treatment site, and information from the monitoring well can be used to adjust the quantity, concentration, and/or distribution of the surfactant, oxidant, and activator to meet the soil conditions, for example, by varying the flow rates of the surfactant pump 126, oxidant pump 128, and activator pump 130, respectfully.

Once the in-situ remediation process has sufficiently removed the residual COCs 412, the injection well 406 can be removed, as shown in FIG. 4D. At this point, clean soil particles 404 and groundwater 405 remain. One or more monitoring wells (not shown) can be used to verify the degree of remediation, and the resulting soil quality.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A system for soil, groundwater, or surface water remediation, comprising:
a water supply including a first fluid stream in fluid communication with a first injection point, and a second fluid stream in fluid communication with a second injection point;
a first surfactant pump adapted to inject a surfactant into the first fluid stream, and a second surfactant pump adapted to inject a surfactant into the second fluid stream;
a first oxidant pump adapted to inject an oxidant into the first fluid stream, and a second oxidant pump adapted to inject an oxidant into the second fluid stream; and
a first activator pump adapted to inject a chemical activator into the first fluid stream, and a second activator pump adapted to inject a chemical activator into the second fluid stream.

2. (canceled)

3. The system of claim 1, further comprising:
a common water pump adapted to pump the first fluid stream to the first injection point, and the second fluid stream to the second injection point.

4. The system of claim 3, further comprising:
a first flow meter adapted to control the flow rate of the first fluid stream to the first injection point; and
a second flow meter adapted to control the flow rate of the second fluid stream to the second injection point.

5-11. (canceled)

12. The system of claim 1, further comprising a first surfactant storage container in communication with the first surfactant pump, and a second surfactant storage container in communication with the second surfactant pump, wherein the first surfactant storage container contains a first surfactant, and the second surfactant storage container contains a second surfactant different from the first surfactant.

13. (canceled)

14. The system of claim 1, further comprising a first oxidant storage container in communication with the first oxidant pump, and a second oxidant storage container in communication with the second oxidant pump, wherein the first oxidant storage container contains a first oxidant, and the second oxidant storage container contains a second oxidant different from the first oxidant.

15. (canceled)

16. The system of claim 2, further comprising a first activator storage container in communication with the first activator pump, and a second activator storage container in communication with the second activator pump, wherein the first activator storage container contains a first activator, and the second activator storage container contains a second activator different from the first activator.

17. (canceled)

18. The system of claim 1, further comprising a controller adapted to control the first surfactant pump, the second surfactant pump, the first oxidant pump, and the second oxidant pump, wherein the controller is adapted to operate the first surfactant pump at a different flow rate than the second surfactant pump, and wherein the controller is adapted to operate the first oxidant pump at a different flow rate than the second oxidant pump.

19-21. (canceled)

22. The system of claim 1, further comprising:
a first inline mixer in fluid communication with the first fluid stream, the first inline mixer adapted to mix the surfactant in the first fluid stream with the oxidant in the first fluid stream;
a second inline mixer in fluid communication with the second fluid stream, the second inline mixer adapted to mix the surfactant in the second fluid stream with the oxidant in the second fluid stream;
a first additional inline mixer in fluid communication with the first fluid stream, the first additional inline mixer adapted to mix the activator in the first fluid stream with the surfactant and oxidant in the first fluid stream; and
a second additional inline mixer in fluid communication with the second fluid stream, the second additional inline mixer adapted to mix the activator in the second fluid stream with the surfactant and oxidant in the second fluid stream.

23-26. (canceled)

27. A system for soil, groundwater, or surface water remediation, comprising:
a water supply including at least a first fluid stream in fluid communication with a first injection point;
a surfactant storage container containing a surfactant;
an oxidant storage container containing an oxidant;
a surfactant pump adapted to inject the surfactant into the first fluid stream; and
an oxidant pump adapted to inject the oxidant into the first fluid stream.

28. The system of claim 27, further comprising:
an activator storage container containing an activator; and
an activator pump adapted to inject the activator into the first fluid stream.

29-31. (canceled)

32. The system of claim 27, wherein the surfactant is made from an oil selected from the group consisting of a naturally occurring biodegradable plant oil, castor oil, coca oil, coconut oil, soy oil, tallow oil, cotton seed oil, and a naturally occurring plant oil; or
the surfactant is selected from the group consisting of Citrus Burst 1, Citrus Burst 2, Citrus Burst 3, and E-Z Mulse, ALFOTERRA 53, ALFOTERRA 123-8S, ALFOTERRA 145-8S, ALFOTERRA L167-7S, ETHOX HCO-5, ETHOX HCO-25, ETHOX CO-5, ETHOX CO-40, ETHOX ML-5, ETHAL LA-4, AG-6202, AG-6206, ETHOX CO-36, ETHOX CO-81, ETHOX CO-25, ETHOX TO-16, ETHSORBOX L-20, ETHOX MO-14, S-MAZ 80K, T-MAZ 60 K 60, TERGITOL L-64, DOWFAX 8390, ALFOTERRA L167-4S, ALFOTERRA L123-4S, and ALFOTERRA L145-4S.

33-35. (canceled)

36. The system of claim 27, wherein the oxidant is selected from the group consisting of: persulfate, sodium persulfate, ozone, peroxide, hydrogen peroxide, a peroxide containing compound, and a percarbonate compound.

37. The system of claim 28, wherein the activator is selected from the group consisting of: a metal, a chelated metal, Fe(II)-EDTA, Fe(III)-EDTA, a base, heat, and hydrogen peroxide.

38-42. (canceled)

43. The system of claim 27 in combination with an extraction system adapted to extract contaminants from the soil or groundwater, wherein the extraction system comprises one or more extraction wells.

44. The system of claim 27, further comprising a skid supporting the surfactant pump, the oxidant pump, the surfactant storage container, and the oxidant storage container.

45. A method of remediating soil, groundwater, or surface water comprising:
pumping a first fluid stream of water to a first injection point at or near a first contaminant of concern;
injecting a surfactant into the first fluid stream using a first surfactant pump; and
injecting an oxidant into the first fluid stream using a first oxidant pump.

46-48. (canceled)

49. The method of claim 45, wherein injecting the surfactant into the first fluid stream and injecting the oxidant into the first fluid stream occur substantially simultaneously.

50. The method of claim 45, wherein the first injection point is located subsurface, and the surfactant and the oxidant are not extracted from the first injection point.

51. The method of claim 45, further comprising:
pumping a second fluid stream of water to a second injection point at or near a second contaminant of concern;
injecting a surfactant into the second fluid stream using a second surfactant pump; and
injecting an oxidant into the second fluid stream using a second oxidant pump.

52-66. (canceled)

67. The method of claim 45, wherein the first contaminant of concern is a nonaqueous phase liquid.

68-73. (canceled)
